(19) United States
(12) Patent Application Publication
(10) Pub. No.: US 2013/0327497 A1
(43) Pub. Date: Dec. 12, 2013

(54) METHOD OF HEATING/COOLING STRUCTURE USING GEOTHERMAL SYSTEM

(71) Applicants: Shawn Genung, Hendersonville, TN (US); Tony Penachio, Stanfordville, NY (US)

(72) Inventors: Shawn Genung, Hendersonville, TN (US); Tony Penachio, Stanfordville, NY (US)

(73) Assignee: GEOENERGY ENTERPRISES, LLC, Katonah, NY (US)

(21) Appl. No.: 13/883,928

(22) PCT Filed: Aug. 3, 2011
(86) PCT No.: PCT/US2011/046398

§ 371 Date: Aug. 14, 2013

Related U.S. Application Data
(60) Provisional application No. 61/411,079, filed on Nov. 8, 2010.

(51) Int. Cl. F24J 3/08; F16L 1/032; F25B 30/06

(52) U.S. Cl. CPC F24J 3/084; F25B 30/06; F16L 1/032
USPC 165/45; 62/260; 62/238.7; 405/154.1

(57) ABSTRACT

A method for installing a geothermal system, comprising boring at least one hole in an earth mass to accept a geothermal column; inserting a geothermal column into each of said at least one hole; excavating trench lines to accommodate connections between said geothermal column in each of said at least one hole and a Heating/Ventilation/Air Conditioning (HVAC) system; filling said hollow tube with a non-antifreeze fluid; connecting said geothermal column to said HVAC system; and backfilling said at least one hole and said trench lines.

### CROSS REFERENCE TO RELATED APPLICATIONS

The present application claims priority to U.S. Provisional application No. 61/411,079 filed Nov. 8, 2010, which is herein incorporated by reference in its entirety.

### FIELD OF THE INVENTION

This invention relates generally to the field of geothermal heating and cooling, and more particularly to an improved heat transfer geothermal method that includes at least one geothermal column positioned within an earth mass for transfer of heat to and from the earth mass.

### BACKGROUND OF THE INVENTION

Any publications or references discussed herein are presented to describe the background of the invention and to provide additional detail regarding its practice. Nothing herein is to be construed as an admission that the inventors are not entitled to antedate such disclosure by virtue of prior invention.

Geothermal energy is becoming more and more important in the global environment as the supply of fossil fuels diminish, the demand for energy increases, control and demands from oil producing companies are at issue and the costs of energy continues to rise. Although large geothermal energy production facilities are being used throughout the world to produce more and more electricity especially in areas like California where there is tremendous inner earth activity, more focus needs to be placed on individual systems which are based on the earth's constant temperature at shallow depths to provide heating and cooling for buildings and which can be installed at the site of use. In order for individual systems to gain broader market acceptance, there is a need for better control of the earth-refrigerant interface, easier installation methods, and greater efficiencies.

### SUMMARY OF THE INVENTION

These features, together with other objects and advantages which will become subsequently apparent in light of the present description, reside in the details of construction and operation as more fully hereinafter described and claimed, reference being had to the accompanying drawings forming a part hereof, wherein like numerals refer to like parts throughout.

An object of the present invention is to provide an improved geothermal method that can include at least one geothermal column that is configured so that it is easy to install, has enhanced heat transfer qualities that uses an antifreeze free liquid disposed therewithin to transfer heat to the surrounding earth mass in substantially vertical orientation. This orientation and approach requires far less digging, drilling and landmass than conventional horizontal and deep vertical well systems and provides low impact to the environment (i.e. is “green”).

One embodiment of the improved geothermal method includes a method of installing a geothermal system comprising boring at least one hole in an earth mass to accept a geothermal heat exchange column; inserting a geothermal heat exchange column into each of said at least one hole; excavating trench lines to accommodate connections between said geothermal column and at least a Heating/Ventilation/Air Conditioning (HVAC) system; filling said column with a non-antifreeze fluid; connecting said geothermal column to said HVAC system; and backfilling said at least one hole and said trench lines.

Another embodiment of the improved geothermal method includes a method of heating/cooling a structure such as a building using a geothermal column comprising circulating a refrigerant through a geothermal column positioned within an earth mass and including at least one spirally wound refrigeration coil configured to communicate with a heat pump compressor, a hollow tube having an outer wall of diameter substantially greater than that of said at least one spirally wound refrigeration coil and positioned so as to surround said at least one spirally wound refrigeration coil and filled with a non-antifreeze fluid, said outer wall having a substantially rigid configuration such that said hollow tube maintains its shape under the ordinary conditions of its deployment, and a support member configured to retain a shape of said at least one spirally wound refrigeration coil and maintain a centrally located, position of said at least one spirally wound refrigeration coil within said hollow tube; and at least one of in a cooling cycle, transferring heat from said refrigerant into said earth mass through said non-antifreeze fluid to cool said refrigerant and cooling said structure using said cooled refrigerant; and in a heating cycle, transferring heat from said earth mass into said refrigerant through said non-antifreeze fluid to heat said refrigerant and heating said structure using said heated refrigerant.

In addition to the above aspects, the substantially rigid hollow tube configuration of the present invention allows for the production of a pre-fabricated unit that can be installed quickly and easily in the field without the need of skilled laborers. The outer wall can be constructed from flexible, rigid, or semi-rigid corrugated material designed to more efficiently transfer heat energy to the environment such that an antifreeze-free liquid vehicle in the hollow tube can be used, which is better for the environment. That is, the improved wall construction and heat circulation within the hollow tube of the present invention is such that antifreeze is not necessary reducing the chance of contaminating the surrounding soil should an accidental leak/spill occur.

The new factory assembled unit of the improved geothermal column of the present invention are positioned within an earth mass whereby during operation, the refrigerant coils transfer heat to and from the antifreeze-free liquid vehicle disposed within the hollow tube to cause a convection cycle within the antifreeze-free liquid to bring the antifreeze-free liquid to a uniform temperature throughout so as to prevent freezing in one part and overheating in others. This configuration and structure results in a superior degree of heat transfer with a total elimination of hot or cold spots.

### BRIEF DESCRIPTION OF THE DRAWING

In the drawing, to which reference will be made in the specification, similar reference characters have been employed to designate corresponding parts throughout the several views.

FIGS. 1A to 1C are perspective views of various stages of cutaways of a geothermal column according to an embodiment of the present invention.

FIG. 2 is a cross sectional view of a geothermal column according to an embodiment of the present invention.

FIG. 3 is a top view of a geothermal column according to an embodiment of the present invention.

FIG. 4 is a perspective view of a geothermal system according to an embodiment of the present invention.

FIG. 5 is a diagrammatic view of the distribution and compressor sections of the present invention.

FIGS. 6A and 6G are diagrams illustrating various geothermal system layouts according to embodiments of the present invention.

FIG. 7 is a flowchart describing a method for installing a geothermal system according to an embodiment of the present invention.

FIG. 8 is a method of heating/cooling a structure using a geothermal column according to an embodiment of the present invention.

FIG. 9 is a diagram of a temperature monitoring system and a water level monitoring system according to an embodiment of the present invention.

FIG. 10 is a diagram illustrating a temperature sensor and a float switch of a geothermal column according to an embodiment of the present invention.

FIGS. 11-13 are various views illustrating embodiments of the present invention.

FIG. 14 is a diagram of an electrical control system for the present invention.

### DETAILED DESCRIPTION OF THE DISCLOSED EMBODIMENT

The present invention may be understood more readily by reference to the following detailed description of the invention taken in connection with the accompanying figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

As used in the specification and including the appended claims, the singular forms “a,” “an,” and “the” include the plural, and reference to a particular numerical value includes at least that particular value, unless the context clearly dictates otherwise.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

The following discussion includes a description of a method of installing a geothermal system of the present invention and includes a method of heating/cooling a structure using a geothermal column of the present invention, related components and exemplary methods of employing the device in accordance with the principles of the present disclosure. Alternate embodiments are also disclosed. The method of the present invention provides a geothermal system that utilizes a vertical geothermal heat exchange column to exchange heat with the surrounding soil environment in an efficient and environmentally safe way. The system is designed to reduce the use of fossil fuels and therefore reduce the carbon footprint associated with conventional heating and cooling systems presently available on the market today.

Reference will now be made in detail to the exemplary embodiments of the present disclosure, which are illustrated in the accompanying figures. Turning now to the drawings, there are illustrated components of the geothermal column in accordance with the principles of the present disclosure.

In accordance with the invention, the geothermal system 100 comprises at least one geothermal column, generally indicated by reference character 10, which includes at least one spirally wound refrigeration coil 11. The spirally wound refrigeration coil 11 can be configured to communicate with a compressor section 30. These connections can be facilitated through ports 20 and 21 located on top cap 19. A refrigerant fluid such as fluorocarbon (e.g., Freon®) optionally containing a lubricant oil (e.g., a hydrocarbon or silicone based lubricant oil) is pumped through the refrigerant coil during operation of the geothermal column.

Also included in the geothermal column 10 is a hollow tube 12. The hollow tube 12 includes an outer wall 13 of a diameter substantially greater than that of the spirally wound refrigeration coil 11. The outer wall 13 can be positioned so as to surround the spirally wound refrigeration coil 11. The outer wall 13 can be of a substantially rigid configuration so that the hollow tube 12 maintains its shape. The geothermal column 10 also can include a support member 14, shown in this embodiment as being comprised of a column 17 and a plurality of combs 18 constructed, for example, as radially extending fins. Annular supports 23 are situated in a manner so as to retain their position within the hollow tube 12. The inner radius of the annular supports 23 is greater than the distance from the center of the column and an extended end 18a of each comb 18 if combs are employed in the embodiment. The combs 18 used in conjunction with the annular supports 23 restrict lateral movement of the support member 14 and allow vertical movement of the support member 14.

A bottom cap 22 is securely attachable to the bottom of the hollow tube 12 in a manner to provide a water tight seal between the bottom cap 22 and the hollow tube 12. The top cap may be fastened to the hollow tube 12 in such a way as to allow removal for service but secure attachment for transport and installation. This removable method of securement may allow for venting of any internal pressures built up within the column 10. The support member 14 is attached to the top cap 19. The support member 14 is configured to retain the shape of the spirally wound refrigeration coil 11. The support member 14 can also function to maintain a centrally located position of the spirally wound refrigeration coil 11 within said hollow tube 12.

The geothermal column 10 is designed to be positioned within a void in a surrounding earth mass (not shown). A non-antifreeze fluid 16 fills the space within the hollow tube 12 and surrounds substantially all of the surface area of the spirally wound refrigeration coil 11; water is a preferred non-anti-freeze fluid 16.

The spirally wound refrigeration coil 11 is sized to optimum performance levels based on system requirements. System requirements can include size of an area to be heated/cooled, geological conditions in and around the geothermal column installation area, etc. The geothermal heat exchange column components are sized independently and as a system to match heat exchange from the copper coil to water to the heat exchange from the water to the earth, while optimizing the trade off between pressure drop and component cost. At the same time, critical oil entrainment velocities are ensured, and coil diameter to column diameter ratios are maintained to facilitate convective mixing in the described annulus. Further, overall dimensions are selected from a limited array of values that are constrained by commonly available materials (e.g. standard copper tube diameters, standard corrugated column diameters and lengths, common augur bit diameters, etc.) and practically maneuvered and transported sizes. Additionally, practicality is exercised in sizing geothermal columns to factors of or fractions of heating and cooling tons (one ton=12,000 btuh and is the commonly used measurement of HVAC system size). The required refrigerant velocity for oil entrainment is given roughly by the equation:

MinimumVelocity=A*SquareRoot(InnerDiameter)

where A is a constant that varies depending upon refrigerant phase and orientation (horizontal or vertical) of flow. Mass flow through each circuit (coil) within the heat exchanger is based on the rated mass flow of the selected compressor and its rated tonnage:

MassFlowCircuit=MassFlowSystem/ColumnsPerSystem/CircuitsPerColumn.

Minimum required mass flow through each circuit is determined by calculating the mass flow through a tube of given diameter in the liquid phase vertical orientation with certain density characteristics:

MinimumMassFlow=MinimumVelocity*CrossSectionalArea*Density(p,t).

Equating MassFlowCircuit to MinimumMassFlow allows a direct relationship between pipe diameter (via CrossSectionalArea) and the required number of circuits per column. Discretion here must be used to select applicable results based on practical applications such as even numbers of circuits or reasonable numbers of circuits relative to creating a practically sized manifold. Given the number of circuits required per column at a given pipe diameter as well as a mass flow at that diameter, and assuming certain operating conditions near the extremes (for example water temperatures near 32 or 90 degrees F.) one skilled in the art can determine the required length of tubing for effecting phase change from liquid to vapor or vice versa. Further, based upon this required circuit length and associated velocity and density at certain conditions including vapor quality, one can determine the pressure drop along the length of the circuit. Finally given the length of circuit, number of circuits, cost of raw materials, and pressure drop along the length, one can evaluate the tradeoff of pressure drop against added cost—both of which impact the success of the invention negatively. The column containment vessel is sized based upon both the volume of the fluid contained, which is a function of the physical dimensions of the containment, and the amount of energy which can be transferred to or from the column which is based upon the temperature differential between the fluid and the earth, the surface area of the transfer medium, and the thermal conductivities of the water, the containment, and the soil. The transfer rate of energy between the heat exchanger coil and the water given adequate minima of design is a function of the number of columns per the rated capacity of the compressor (e.g. two columns per ton), and as such the minimum design of the geothermal column is to sufficiently match that het exchange into the earth. As the energy is absorbed or rejected by the earth, the earth will subsequently change temperature. As the temperature is measured in all directions away from the heat exchange column, the temperature change asymptotically approaches zero. Based upon a proposed work load of the system and an allowable earth temperature change rate, the minimum required geothermal column spacing can be determined for a geothermal column of particular size and energy transfer rate.

In a preferred embodiment at least one of upper oil trap 24, upper oil trap 25, and lower oil traps 26 provided oil entrainment and return. Oil entrainment and return is a critical design issue in nearly all HVAC products, as standard compressors are sealed and do not contain independent oil reservoirs. As such, the compressor relies on the refrigerant to carry oil away from and returning to the compressor in order to maintain lubrication. While the oil is designed to be miscible in the refrigerant, there is a certain velocity that is required in order to keep the oil from falling out of suspension. Oil separation resulting from poor design or improper operation can result in insufficient return and ultimately compressor failure. Additionally, in long piping runs or in unusually high vertical drops, oil which has naturally fallen out of suspension upon shut down of a system has a tendency to migrate to a natural low point. Often when the system is restarted, that oil only very slowly or never returns to the compressor. Vertical drops and rises and long piping runs are unavoidable aspects of the present invention. Embodiments of the present invention include optimized piping sizing to ensure sufficient oil entrainment, but also include newly designed oil traps into the piping configuration. Oil traps 24, 25 and/or 26 are incorporated at the top entrance and exit points of the spirally wound refrigeration coil 11. Upper oil traps 24 and/or 25 include a loop design having loops approximately 8″ in diameter oriented in a vertical plane. Lower oil traps 26 include a U-bend design.

Spirally wound refrigeration coil 11 includes one or more individual sections. In the drawings two sections 11a and 11b are shown. While individual sections are coiled and stacked vertically along the column 17, the lower exit of each coil extends to the lowest point in the column to equalize pressure head among all sections and to equalize the oil “plug” induced pressures among all circuits, aiding in oil return from the lowest points in the systems. That is, each section 11a and 11b are equal in length. By varying the number of sections, the heating/cooling capacity of the geothermal column 10 can be varied. For example, each section can represent ¼ of a ton of conditioning capacity—i.e. two sections can be incorporated into a ½-ton geothermal column 10, and four sections can be incorporated into a 1-ton geothermal column 10. As stated above, each section should preferably be of substantially equal length in order to ensure equal refrigerant distribution to each column as a result of pressure differentials.

Sections 11a and 11b of the spirally wound refrigeration coil 11 can be so arranged such that the refrigerant enters at a plurality of positions in the coil and exits from the upper region. This arrangement assures that there is an equal distribution of refrigerant in the spirally wound refrigeration coil 11 so that the heat transfer can be uniform throughout the device, which, in turn, can prevent sections of the tubing from overheating or freezing.

Sections 11a and 11b of the spirally wound refrigeration coil 11 are preferably constructed from copper tubing. The tubing, which is preferably between one-eight of an inch to 1 inch in diameter, are in substantially full contact with the non-antifreeze liquid 16 in the hollow tube 12. The diameter of the tubing is determined by the number of columns and the cooling/heating capacity that the system is designed to cool/heat. By design, the non-antifreeze liquid 16 contained within the hollow tube 12 at the lower region is heated to a greater temperature than at the upper region, which causes the water within the tube to move upward to create a cyclic motion.

Depending upon operational mode (that is, heating or cooling mode), continuing compressor operation may cause an increase in the temperature of the lower region thereby increasing the rate of flow of the tube and, as a result, the mixing rate of the liquid mass is also increased. Since heat transfer is a function of temperature difference, the greater the difference between the refrigerant temperature and the water, the greater the heat transfer there between. Similarly, as heat is transferred from the refrigerant to the water, the difference between the water and the earth mass increases as does the heat transfer.

In a preferred embodiment the hollow tube 12 has a diameter between 12 and 40 inches and a length between 12 and 30 feet. Also in a preferred embodiment the spirally wound refrigeration coil 11 has a spiral diameter of between 4 and 16 inches and a spiral length of between 10 and 100 feet, and an overall length between 30 and 150 feet.

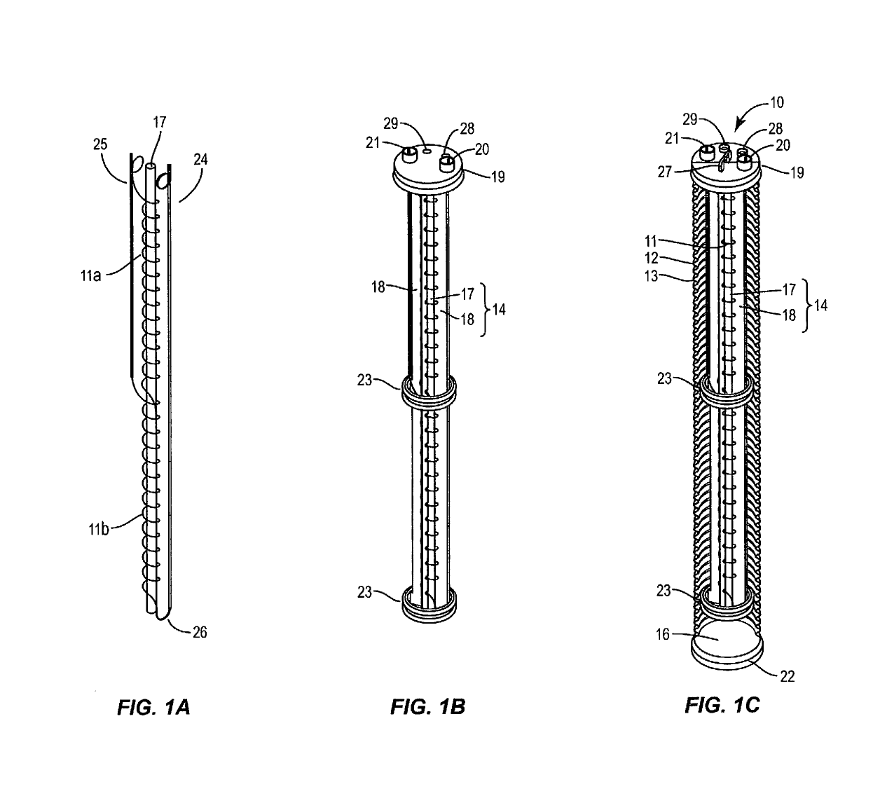

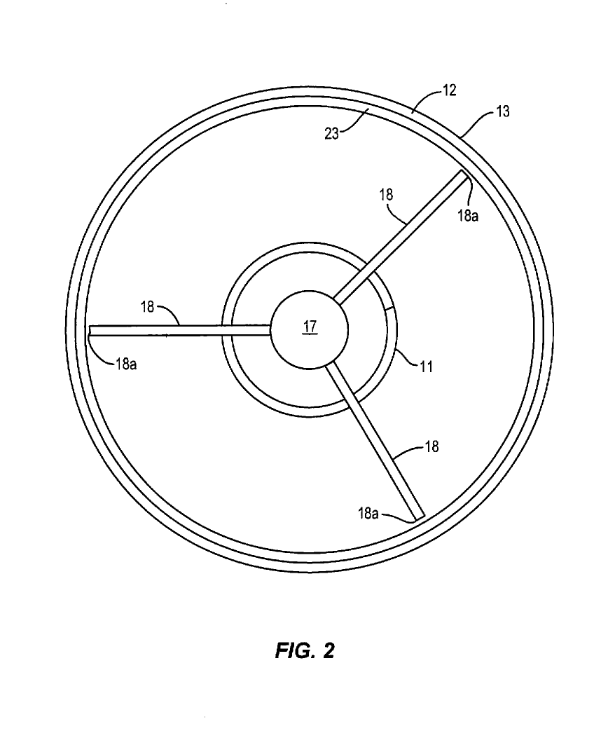

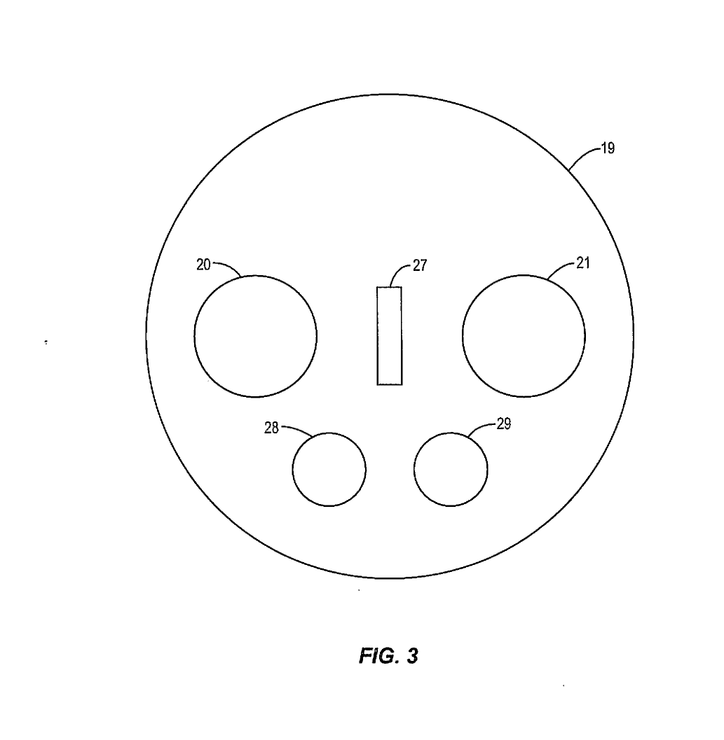

Although the support member 14 is depicted in FIGS. 1A to 1C as a column 17 and a plurality of combs 18, the support member 14 can be configured in other forms. As stated above, one use of the support member 14 is to maintain the form of the spirally wound refrigeration coil 11, while another use of the support member 14 is to maintain the lateral position of the spirally wound refrigeration coil 11 within the hollow tube 12. Yet another use of support member 14 is to provide vertical lifting support to the spirally wound refrigeration coil 11 during repair and/or replacement, to be described in more detail below.

In light of these uses, column 17 can be for example tubular in nature, i.e. a pipe, a thin rod, etc. Another embodiment envisions the use of spacing clips or attachment devices that can be secured to the tubing of the spirally wound refrigeration coil 11 to maintain an evenly spaced coil.

Lift support 27 is provided on the top cap 19 of the geothermal column 10 to provide an attachment location for lifting means to lift the geothermal column 10. Lifting is required during installation and repair. During the installation process the top cap 19 can be secured to the hollow tube 12 and the entire geothermal column 10 can be lifted to be inserted into a pre-bored hole in the earth. During repair, the top cap 19 is unsecured from the hollow tube 12 and the top cap 19 the support member 14 and the spirally wound refrigeration coil 11 can be removed for inspection and access. This repairable design is unique to the present invention and prevents the need to excavate the entire geothermal column 10 for repair. Even in the event that the hollow tube 12 develops a leak, the top cap 19 the support member 14 and the spirally wound refrigeration coil 11 can be removed to effect a repair on the hollow tube 12. one embodiment of the repair envisions the use of a flexible non-porous insert that can be inserted into the hollow tube 12, and into which the top cap 19 the support member 14 and the spirally wound refrigeration coil 11 can be reinserted.

Also shown on top cap 19 are ports 28 and 29. Ports 28 and 29 can be used for access to the interior of hollow tube 12. Access can be used to fill the hollow tube 12 with the non-antifreeze fluid 16 after the geothermal column 10 is installed. In addition, a temperature sensor and fluid level switch (not shown) can be installed and accessed through ports 28 and/or 29.

The geothermal column 10 is not a sealed unit, and as such, changes in temperature can result in expansion and contraction of the geothermal column 10 and subsequently the earth surrounding it. As such, there is moderate opportunity for water to escape as a result of evaporation during operation of a system incorporating a geothermal column 10. Loss of the non-anti-freeze fluid 16 can be detrimental to the efficient operation of the system incorporating a geothermal column 10. In order to mitigate this possibility, a float switch at the top of each geothermal column 10 wired to a single or multiple water solenoid valve(s) (not shown) and a power supply can be included. The solenoid valve(s) is/are plumbed into a water supply and, upon the triggering of the circuit by the float switch indicating an insufficient water level, water can be added to the geothermal column 10. Low water level alarms and/or indicators can also be incorporated into the system.

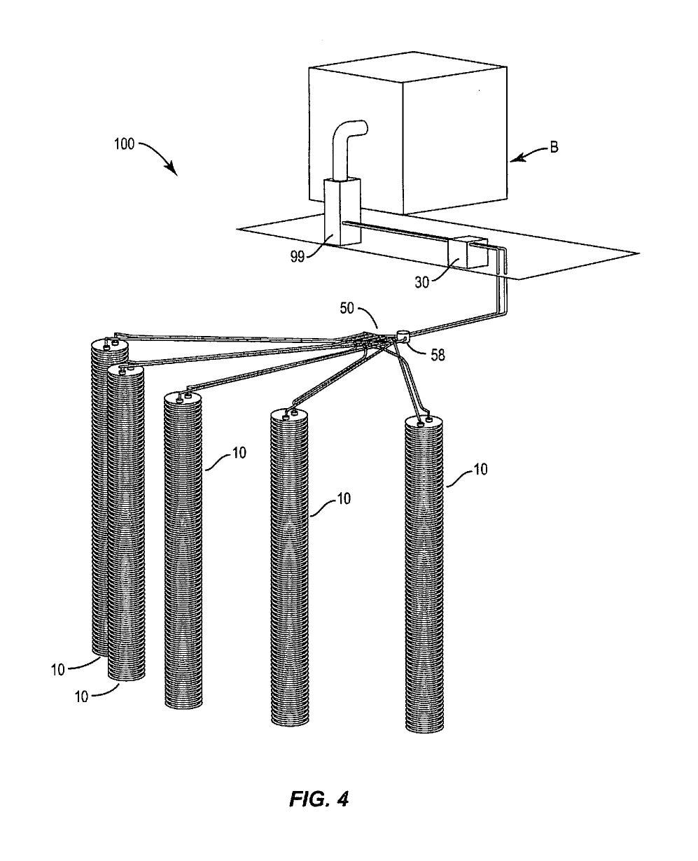

Referring to FIG. 4, in a preferred embodiment, a plurality of geothermal columns 10 are provided in the geothermal system 100. A preferred embodiment can also include a compressor section 30 and a distribution section 50. The geothermal system 100 is configured to be in communication with a climate system 99 for a structure such as a building B. The climate system can be at least one of a heating system and a cooling system.

The geothermal system 100 is a closed refrigerant system. HCFC refrigerants are contemplated, and can include the industry standard R-22. Other refrigerants can include HFC refrigerants, for example, R-407C and R-410A. Both of these HFC refrigerants are zeotropic blends of other HFC refrigerants that provide both usability and high efficiency potential. R-407C shares similar psychometric properties as HCFC R-22, while R-410A operates at pressure and temperature ranges in the range of 75% higher than R-22. R-410A is marginally more efficient than R-407C and has emerged as the new standard in Heating-Ventilation-Air Conditioning (HVAC) equipment. While equipment design characteristics for R-407C are essentially identical to the former R-22 equipment with the exception of the use of polyolester oil rather than mineral oils as lubricants, R-410A requires different tubing lengths and diameters, pressure vessels and ports, and some critical components (compressors, TXVs, etc.)

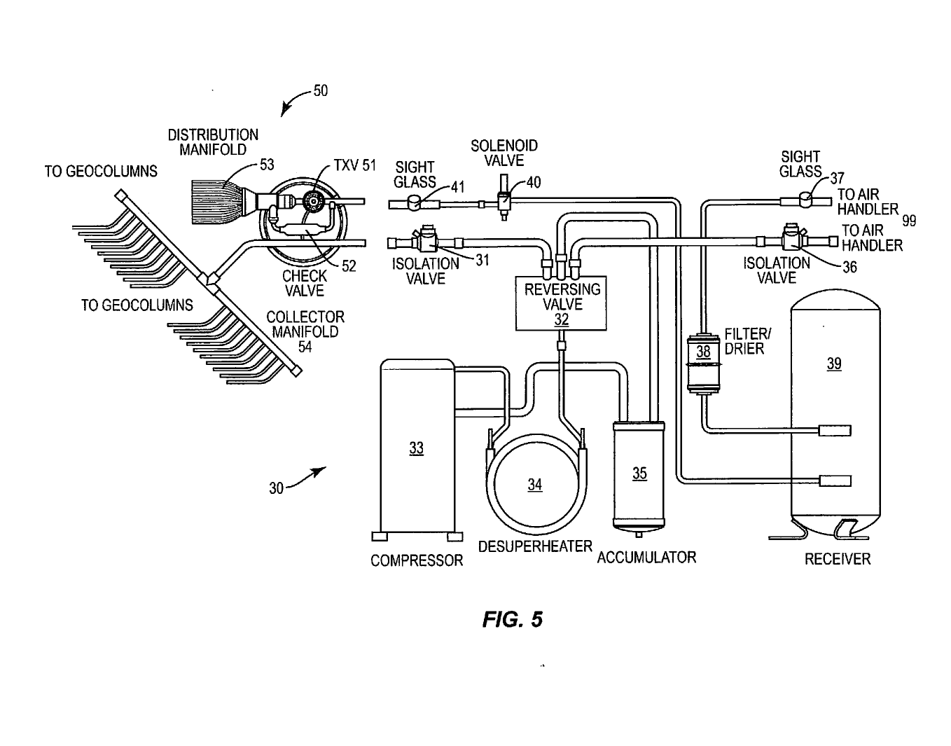

Referring to FIG. 5, the distribution section 50 can include a Thermostatic Expansion Valve (TXV) 51, a check valve 52, a distribution manifold 53 and a collector manifold 54. Each of the geothermal columns 10 can be connected to an output of the distribution manifold 53 and an input of the collector manifold 54. In this manner, the geothermal columns 10 are connected in a parallel fashion with each other. This provides for even distribution of heating and cooling among the geothermal columns 10. This also provides to equally distribute the refrigerant into each of the geothermal column 10 spirally wound refrigeration coil 11 sections 11a and 11b. Parallel distribution also provides multiple points of entry into the heat exchange process resulting in heat exchange driven by greater temperature differences at each of the multiple points as opposed to a single point of maximum temperature differential followed by a subsequent extended length of heat exchange device interacting at reduced and less effective temperature differential. Additionally these multiple shorter lengths allow for smaller diameter tubing resulting in more surface area per volume than a necessarily larger diameter tube. The TXV 51 can be connected to the input of the distribution manifold 53. A check valve 52 can be included in parallel but opposite functional direction with the TXV 51.

The TXV 51 can be included to provide adiabatic expansion (pressure drop and temperature drop but no energy loss) of the refrigerant. The TXV 51 is a sophisticated method of providing for the adiabatic expansion in that the orifice opening through which the high pressure refrigerant flows has a variable size, and this size is controlled by the downstream temperature and pressure of the refrigerant. An embodiment of the present invention utilizes a single TXV 51, sized for the corresponding system size (e.g. tonnage) which is close-coupled to the distribution manifold 53.

In an alternate embodiment, a single smaller TXV can be placed within each geothermal column 10 (e.g. a ½-ton TXV within a ½-ton geothermal column and/or a 1-ton TXV within a 1-ton geothermal column), along with the removal of the centrally located TXV 51. In this alternate embodiment, the refrigerant tubing arrangement is simplified from a radial array with multiple circuits running to each geothermal column 10 to a common supply and return pipe running from one geothermal column 10 to the next. This is made possible due to the fact the each geothermal column 10 can be regulated by its own TXV, and as such the system can perform in a more naturally balanced manner. System efficiencies should likewise increase due to the reduced length of restrictive copper tubing. From a cost perspective, the amount of copper is substantially reduced, as is the amount of trenching required. This also in turn results in an increased ease of installation by reducing trenching and connection complexity. The alternate embodiment also represents an improvement over the current technology in that geothermal column(s) placed in areas of differing subsurface conditions (e.g. one column in a high-water table area with another in dry sand) would traditionally result in a misbalanced system where refrigerant follows a path preferring one column over the other as a result of temperature and/or pressure conditions and in turn underutilizes the remaining geothermal column(s). However in the alternate embodiment, each geothermal column 10 functions at optimum efficiency as a result of localized controls. Another improvement effected by the alternate embodiment is the ability to further componentize the system with regards to sales and installation by removing an entire system component, and second by defining each geothermal column 10 as a standalone unit rather than a heat exchanger which is reliant upon additional components. In this embodiment, the columns still interact in a parallel manner (refrigerant does not travel from one column to any subsequent column) although the supply and return piping is contained within a single trench which connects each of the columns in a single loop.

Referring to FIG. 5, compressor section 30 can include a first isolation valve 31, a reversing valve 32, a compressor 33, a desuperheater 34, an accumulator 35, a second isolation valve 36, a first sight glass 37, a filter/dryer 38, a receiver 39, a solenoid valve 40 and a second sight glass 41. The first and second isolation valves 31 and 40 are typically pall or gate type valves which serve the purpose of allowing the isolation of various sections of the system as a whole so that the various isolated sections can be serviced by removing the refrigerant and or pulling the section into a vacuum state. These also allow the compressor section as an independent unit to be transported and stored in a pressurized or vacuum state. The reversing valve 32, also known as a four-way valve, provides the ability to redirect the flow of refrigerant gases so that the system can function in either a heating (heat pump) or cooling (air conditioner) mode by electrical control mechanisms. The compressor 33 is a device, preferably a hermetically sealed scroll type compressor but possibly of multiple other refrigerant compressor designs, which compresses refrigerant typically from a lower pressure gas phase to a higher pressure liquid phase. The desuperheater 34 is a water-to-refrigerant heat exchanger which is designed to provide heated water to the user at a relatively low cost. The accumulator 35 is a hollow canister with two ports which is used primarily to flash liquid refrigerant to a gaseous state prior to entering the suction side of the compressor, where liquid refrigerant could cause damage. The first and second sight glasses 37 and 41 consist of components with transparent windows within the piping arrangement that allow for visual observation and confirmation of liquid levels and quality entering and leaving the receiver 39. The filter/dryer 38 is a component containing an absorbent material and filter medium used for preventing such contaminants as water, acids, and/or particulates from moving throughout the system. The filter/dryer 38 is necessarily a bi-directional flow component, as the refrigerant flow through the filter/drier changes direction from one mode to the other (heating to cooling). The receiver 39 is a hollow canister type component designed to hold excess levels of liquid refrigerant as is required when switching between the two operational modes. This is necessitated by the typical difference in the internal volume of the heat exchange coils within the air handler unit and the geothermal heat exchange columns. This device must also be designed to operate bi-directionally as mode change will reverse refrigerant flow. The solenoid valve 40 is an electrically operated refrigerant shut-off valve which is interlocked with the operation of the compressor 33 to prevent liquid refrigerant from flowing from the receiver 39 to the geothermal heat exchange columns and/or into the accumulator 35, which would cause significant amounts of liquid refrigerant to enter the suction port of the compressor upon startup. Various other designs of a compressor section are contemplated wherein not all of the above components are included or additional components are included. The first isolation valve 31 is configured to be in communication with the collector manifold 54. The second sight glass 41 is configured to be in communication with the distributor manifold 53. The second isolation valve 36 and the first sight glass 37 are configured to be in communication with the climate system 99. In a preferred embodiment climate system 99 is an air handler system. As stated above climate system 99 can be a heating system, a cooling system, or a combination heating/cooling system associated with a structure such as building B (FIG. 4). Also, although an air handler system is described herein, other heating and/or cooling systems are contemplated; for example, a hydronic heating system can be utilized.

The installation of a geothermal system 100 according to an embodiment of the present invention includes a planning stage. During the planning stage, the HVAC system 99 requirements for heating/cooling a structure are determined. Also, the soil conditions as well as potential subsurface hazards (septic tanks, electrical lines, etc.) in the location of the geothermal columns 10 are determined. Based on the HVAC system 99 requirements and soil conditions, the number of geothermal columns 10 required is then determined. In addition, the locations of the HVAC system 99 components, including air handler or other delivery unit, and the compressor section 30 to be utilized in the structure are determined. The location of each geothermal column 10 is also determined. Next, the distance between all the system components is determined. This includes, but is not limited to, the distances between the HVAC system 99 and compressor section 30, the compressor section 30 and the distribution section 50, and the distribution section 50 and each geothermal column 10.

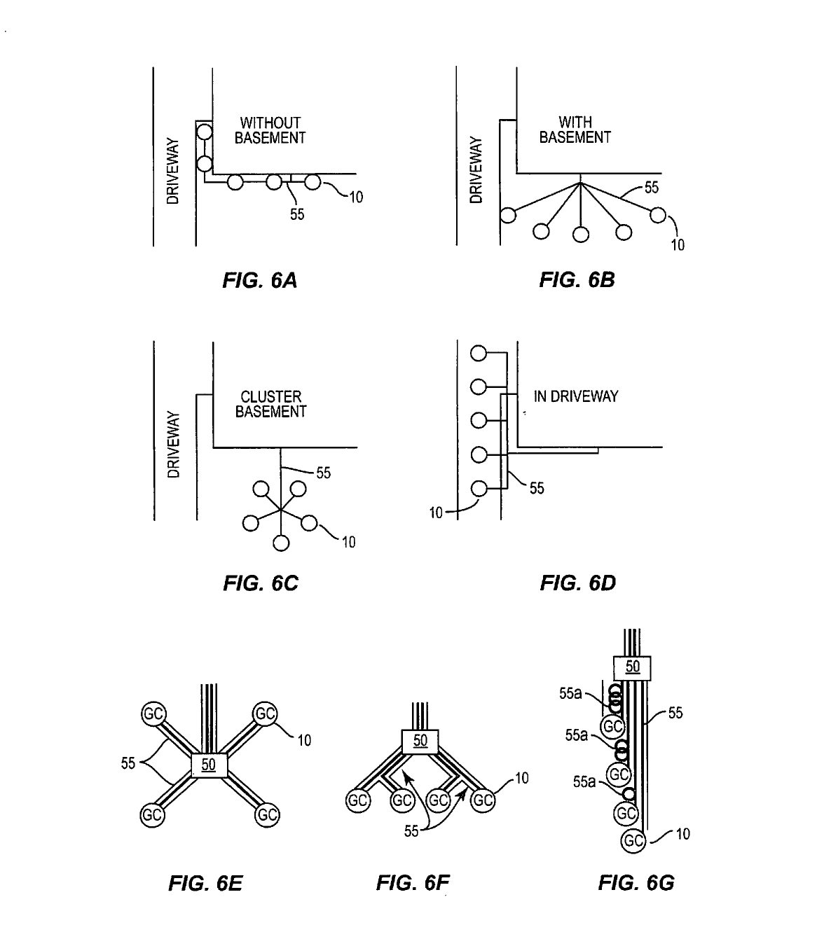

FIGS. 6A to 6G are diagrams illustrating various geothermal system layouts according to embodiments of the present invention. As illustrated in FIGS. 6A-6G, many different layout plans are available and can be modified during the system planning and subsequent installation stages. Depending upon the design of a preferred embodiment, geothermal columns 10 can be placed on a specified minimum center-to-center spacing which is directly relative to the characteristics of the embodiment. In a preferred embodiment, each geothermal column 10 is 20′ in height and 28″ in outer diameter, requiring a minimum 23′ deep well drilled with a 30″ augur. The distribution section 50 is provided with each geothermal system 100 containing the appropriate number of piping ports for the unit tonnage. Line sets 55 are provided for connecting each geothermal column 10 to the distribution section 50. In a preferred embodiment, each line set 55 consists of two insulated ¼″ lines and two insulated ⅜″ lines. The insulated lines can optionally have a diameter of up to 1.0″. In a preferred embodiment, line sets 55 to each geothermal column would further be enclosed in a continuous length of 4″ diameter flexible piping which provides for ease of installation, water tightness relative to the saturation of the piping insulation, and a protective barrier to prevent refrigerant from contaminating the soil in the case of a refrigerant leak. For example, line sets 55 for a 2.0 ton through a 3.0 ton geothermal system 100 can be 26′ in length, while line sets 55 for a 3.5 ton through a 5.0 ton geothermal system 100 can be 38′ in length. The line set lengths are specifically designed to balance the geothermal system 100 and should not be modified or shortened. The geothermal columns 10 can be arranged in any pattern allowed by the physical constraints of the site as long as the minimum spacing and standard geothermal column 10 to distribution section 50 line set 55 dimensions are maintained. Multiple line sets 55 can be laid in the same trench, and/or line sets 55 can be looped or coiled as shown in sections 55a to shorten the trenching length without modifying the total line set 55 length to the geothermal column 10.

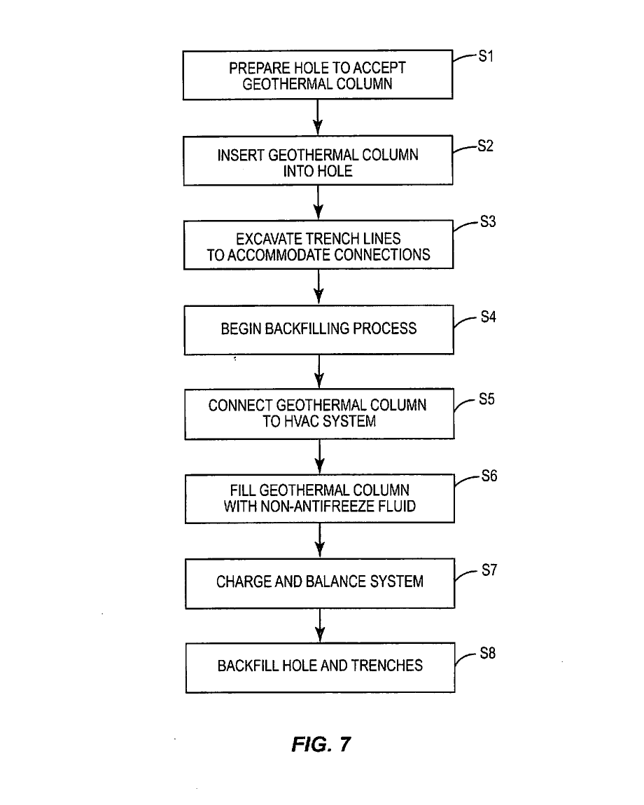

FIG. 7 is a flowchart describing a method for installing a geothermal system according to an embodiment of the present invention. In step S1, borehole(s) are created in the earth mass. As discussed below, other methods of excavating the earth mass are available. In step S2 a geothermal column 10 is placed within each borehole using lift support 27. In step S3, trenches are excavated to accommodate the distribution section 50 and line sets 55. The trenches can be 4″ to 30″ wide and extend from the entry point to the compressor section 30 within the structure to the location of the distribution section 50, and from the distribution section 50 to each geothermal column 10. The distribution section 50 to geothermal column 10 trenches can be a common trench or multiple trenches or a combination thereof. The trenches can be dug level and at a minimum of 36″ deep from grade or as specified during the planning stage.

In step S4 the process of backfilling the boreholes containing the geothermal column(s) 10 is commenced. In order to compact the soil and ensure good soil adhesion around the geothermal column 10, water is applied on the fill area during the backfill operation. Once the backfill operation reaches near the top cap 19 of the geothermal column 10, the top cap 19 should be clean and well exposed and free of any spoils, dirt or rocks.

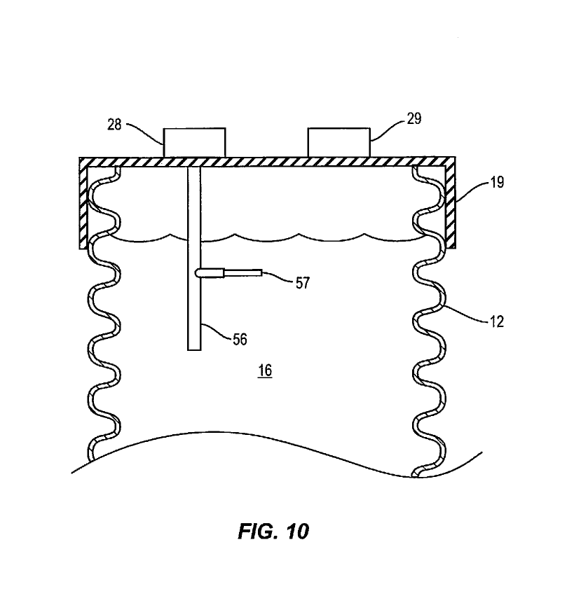

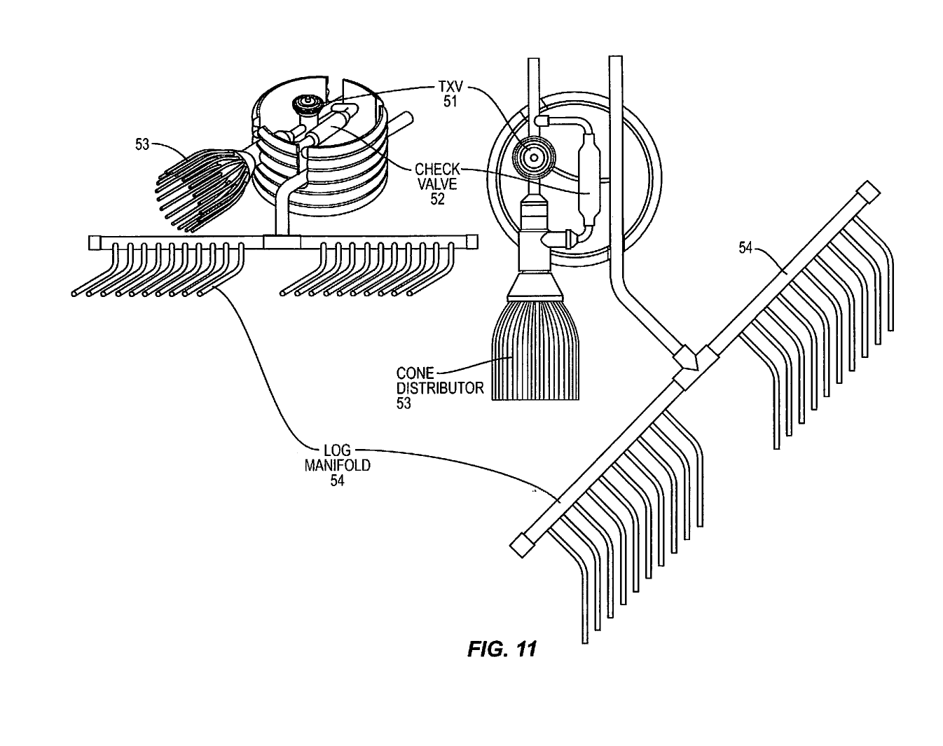

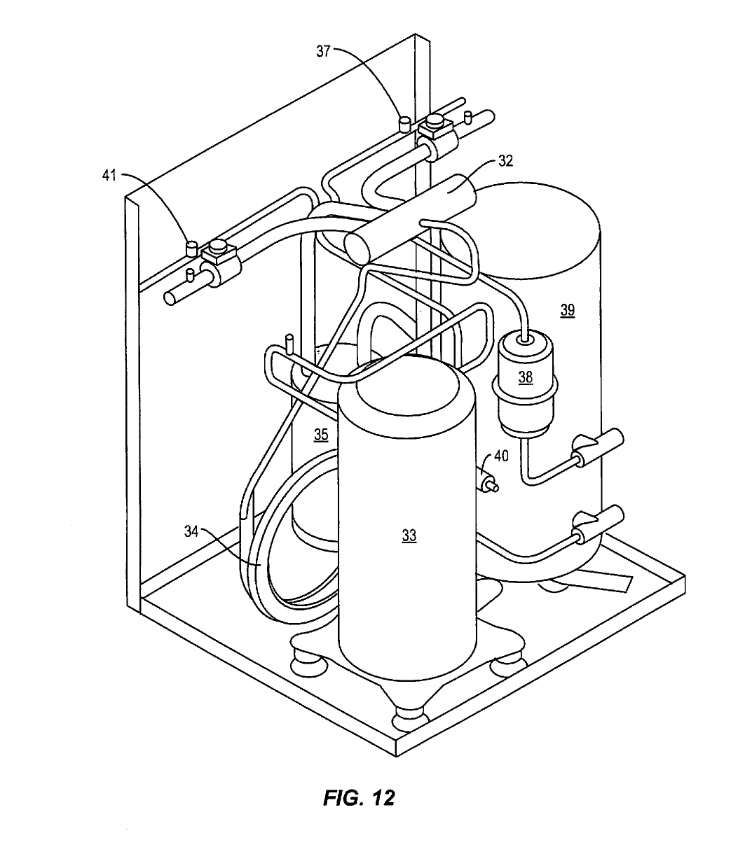

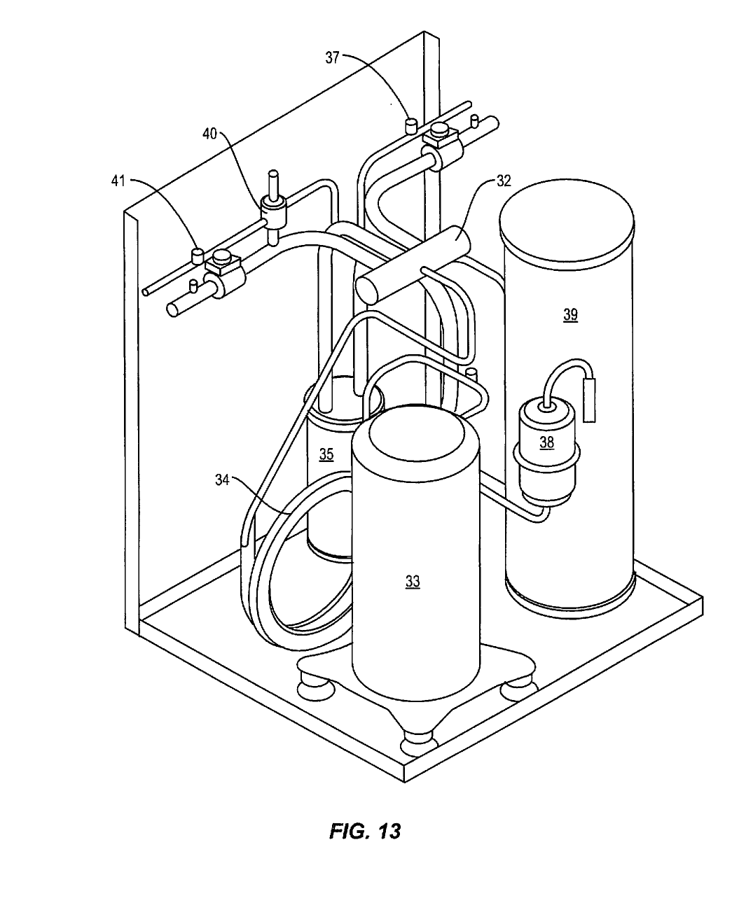

In step S5 the connections between the HVAC system 99, the compressor section 30, the distribution section 50 and the geothermal columns 10 are made. These connections included in the line sets 55 can include refrigerant lines, water lines and electrical lines. A water supply line can be included to each geothermal column 10 to replace water lost during the operation of the geothermal system 100 using the fluid level switch. The temperature sensor 56 and the fluid level switch 57 of each geothermal column 10 can be connected using the electrical lines. After all line sets 55 are in place and connected, a pressure test can be applied to the system to inspect for leaks in the system, if any. FIG. 10 illustrates a temperature sensor 56 and a fluid level switch 57 of a geothermal column according to an embodiment of the present invention.

A water distribution unit 58 (FIG. 4) can be included and can contain a common valve or a separate valve for each water supply line to each geothermal column 10 under control of the fluid level switch 57. In a preferred embodiment, the water distribution unit would be located indoors in a serviceable location. A temperature monitoring system 60 can include the temperature sensor 56 and a water level monitoring system 61 can include the fluid level switch 57 and water distribution unit 58. The temperature monitoring system 60 can be included to monitor the temperature of the geothermal columns 10 and in the event of a high temperature or low temperature condition can add cooled or warmed water as required, activate an alarm and/or shut down the system to prevent damage to geothermal system 100 components. In addition, the water level monitoring system 61 can be included to monitor the water level in each geothermal column 10 and turn on a water supply valve in the water distribution unit 58 in the event of a low water level condition detected by the fluid level switch 57. In step S6 the geothermal columns 10 are filled with the non-antifreeze fluid, preferably tap water. Low water level indicator lights 62 can be included in the water level monitoring system 61 to indicate a low water level condition. In step S7 the refrigeration system is charged, started and balanced. In step S8 the boreholes and trenches are backfilled. Normal geothermal system 100 operation can now proceed.

As stated above, an alternate embodiment can utilize a standard medium to large construction excavator capable of creating a trench, hole or holes that are a minimum 25 feet deep by 30 inches wide. Using the large type excavator to install the geothermal columns 10. For example, the large excavator operator could create trenches of 30″ wide by 23′ deep and long enough to accommodate the geothermal columns 10. After breaking the ground and excavating to the 23′ depth the excavator could place a first geothermal column 10 in the trench and then continue the excavation using the spoils to fill around the first geothermal column 10 installed and continue the process until all geothermal columns 10 were inserted and back filled. The same machine could be used to excavate for the distribution section 50 and create the shallow trenches. In yet another alternate embodiment, a “hydro-vac” type soils excavator could be used to create both the boreholes and the shallow trenches. A hydro-vac excavator is normally a truck-mounted machine that uses a high vacuum pump, sometimes combined with a high-pressure water stream (with such hp water stream used to break up surface highly compacted soils), to actually suck the soil out of the earth's mass. In addition, caisson-type truck or track mounted pressure drilling equipment or, telephone pole-type truck or track mounted “dangle” diggers utilizing either single, double, triple or continuous flight augers of 28″ minimum in diameter, may also be employed to create the boreholes.

In determining the planning and the method of excavating, variations in the subterranean conditions should be considered. Two major substrata variations that can require modification of the planning and the method of excavating are high water tables and consolidated substrata.

A high water table can be considered to be any occasion where the level of the ground water is higher than the lowest point of the geothermal column 10 as installed below ground. This high water table can be the result of the site's location being close to a coastal water body; an inland lake, stream or river; an underground river or pond; or other, more unusual incidents such as site locations close to agricultural production areas utilizing large amounts of irrigation water. Such underground water issues can be often identified by use of test borehole data as often required in the installation of septic systems. Other methods of verifying high water table substrata composition would be local knowledge, water well information, prior mapping, Ground Penetrating Radar (GPR), etc. In such incidents special techniques can be required.

In the utilization of pressure drill or dangle digger equipment: after the earth auger can no longer maintain the spoils on the flights of the auger the drill operator will remove the earth auger and in it place install a “bucket” drill or other such device utilized to remove a soils slurry from the borehole. This technique often, if not always, requires that a casing (a casing being a steel, concrete, plastic, or other material, smooth wall pipe of various diameters, so that the geothermal columns 10 slide into the casing, and lengths, as required) to be inserted into the borehole for the purpose of preventing the borehole from collapse during the excavation of the soil/slurry. This casing is normally pushed lower, during the bucket drilling process, by use of the pressure of the bucket against the casing. Once the drilling machine has reached the desired depth the geothermal column 10 is inserted inside the casing and as the excavated area will normally refill with groundwater, the geothermal column 10 can require filling with water to sink the unit into the borehole by displacement. Once the geothermal column 10 has been set the casing can either be left in place or removed (pulled out) by the mast's cable.

In the utilization of hydro-vac equipment a similar type casing cab be required and pushed to lower depths as the hydro-vac excavates the slurry (with the pushing downwards on the casing by the assistance of a bobcat, backhoe or similar light excavation equipment). In this incidence the casing most likely would remain in place, as the equipment utilized would most likely not be capable of the removal of the casing from the borehole.

Consolidated substrata indicates a solid mass of consolidated materials that may have formed underground and sometimes at the surface due to various environmental and geological reasons. Identification of such conditions is similar to methodology described above of test borehole data as often required in the installation of septic systems, local knowledge, water well information, prior mapping, ground penetrating radar, etc. It is important to know the composition of these consolidated substrata, in terms of hardness of the material, so as to properly plan the drilling operation and to use the proper drilling equipment and drilling bits. Equipment for this type of drilling operation could be limited to truck, track or excavator mounted pressure drilling equipment. After drilling through the consolidated materials and the insertion of the geothermal column 10 has been made other materials such as grout maybe necessary or substituted for the spoils/water mix.

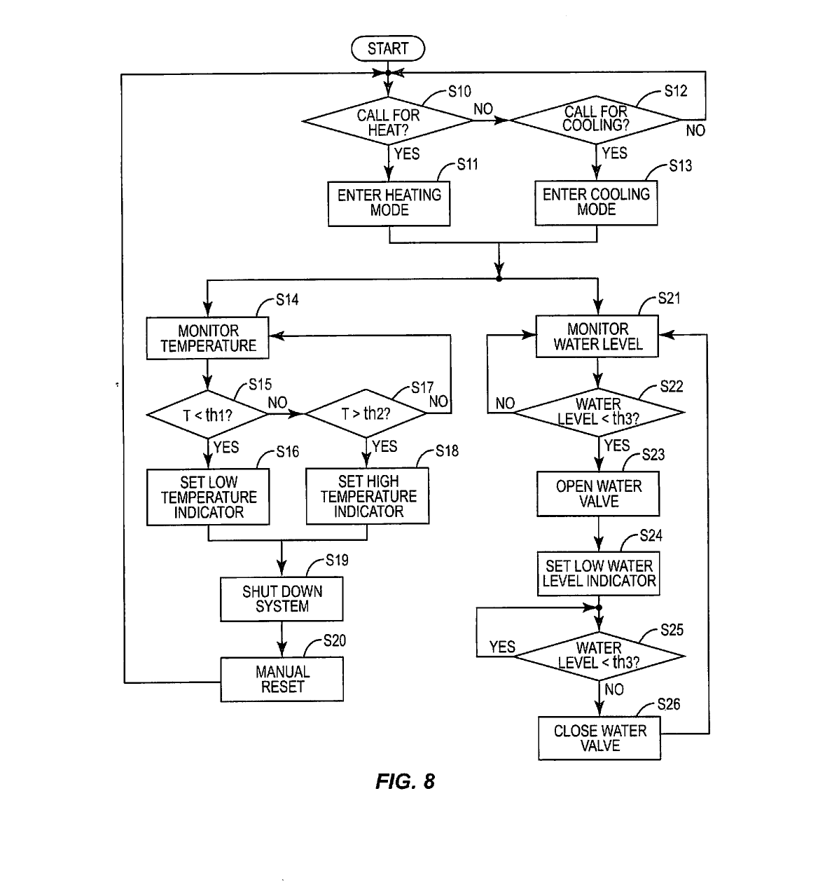

FIG. 8 is a method of heating/cooling a structure using a geothermal column according to an embodiment of the present invention. Upon system start, in step S10 the controller determines if there is a call for heat. If so, in step S11 the controller enters the heating mode. If heat is not called for, in step S12 the controller determines if there is a call for cooling. If so, in step S13 the controller enters into the cooling mode. If cooling is not called for, the controller returns to step S10.

In step S14 the controller monitors the temperature of the fluid in each geothermal column 10. In step S15 the controller determines if the temperature T is less than a first threshold th1. If so, in step S16 the controller sets a low temperature indicator to alert an operator that a low temperature condition has occurred. If T is not less than th1, in step S17 the controller determines if T is greater than a second threshold th2. If so, in step S18 the controller sets a high temperature indicator to alert an operator that a high temperature condition has occurred. If T is not greater than th2, the controller returns to step S14 to continue to monitor the temperature. If either T is less than th1 or greater than th2, in step S19 the controller shuts down the geothermal system to protect the geothermal columns 10 from damage. In step S20 the controller awaits for a manual reset and then returns to start. The controller may also add either cooled or warmed water to the geothermal column as required to maintain maximum performance under high stress loads.

In step S21 the controller monitors the water level in each geothermal column 10. In step S22 the controller determines if the water level is less than a third threshold th3. If not, the controller returns to step S21. If the water level is less than th3, in step S23 the controller opens a water valve for a corresponding geothermal column 10 to refill the geothermal column 10 with the low water condition. In step S24 the controller sets a low water level indicator to alert an operator that a low water level condition has occurred. In step S25 the controller determines if the water level is still less than th3. If so, the controller continues to refill the geothermal column 10. If the water level is no longer less than th3, in step S5 the controller closes the water valve and returns to step S21.

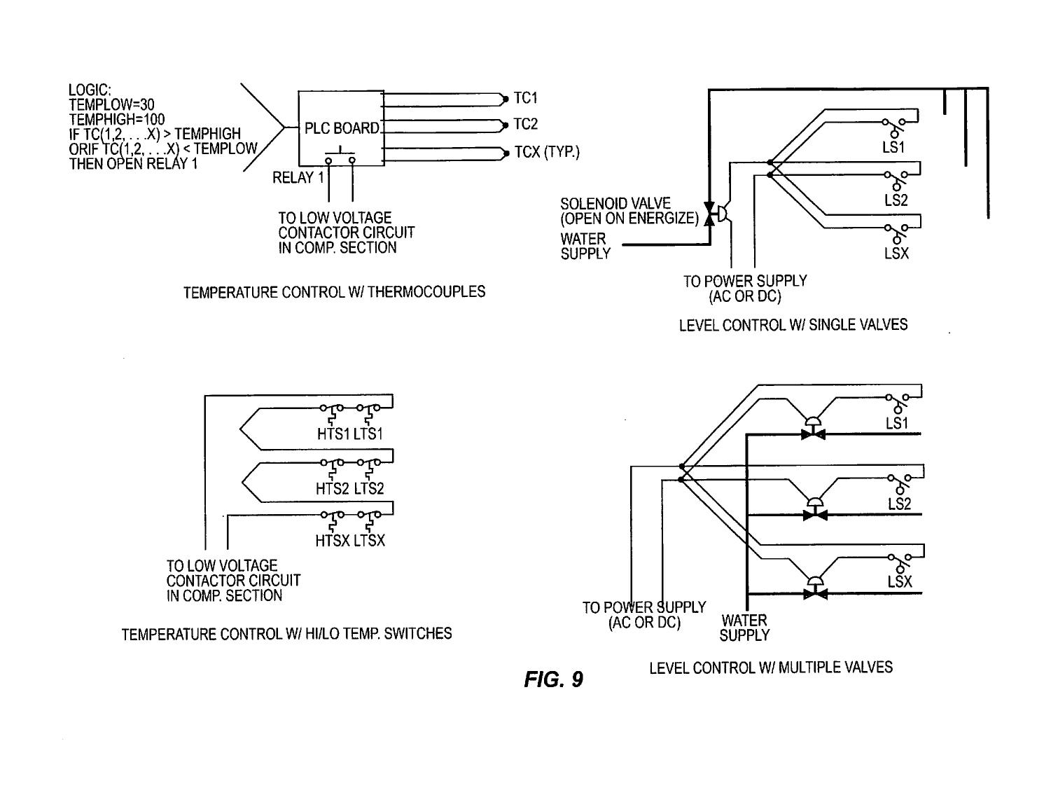

FIG. 9 shows the temperature monitoring system 60 and the water level monitoring system 61 according to an embodiment of the present invention.

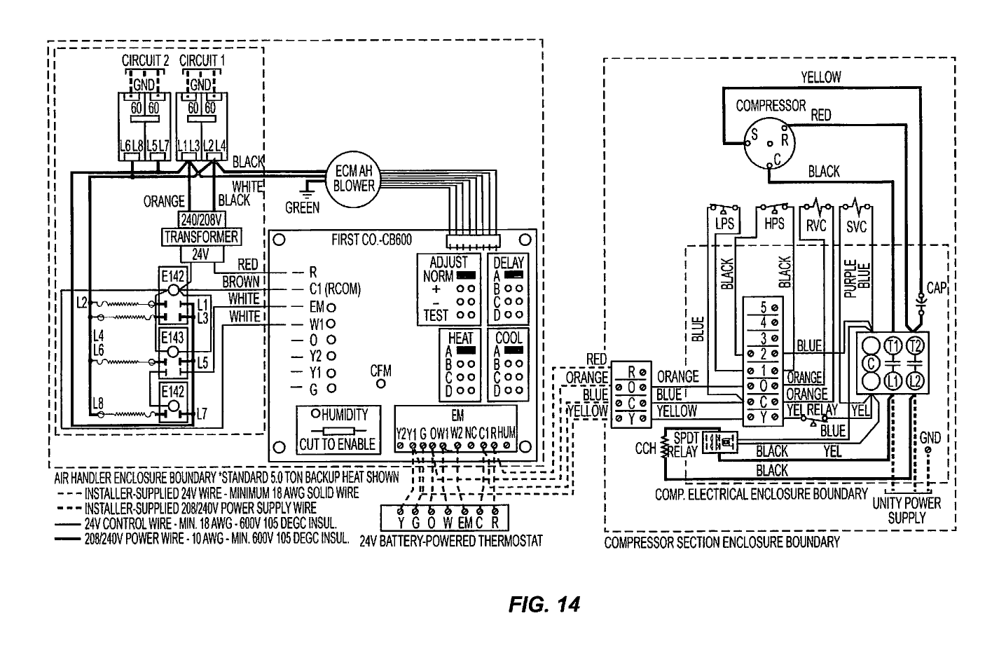

FIG. 14 diagrammatically illustrates electrical control systems for the air handler and the compressor section.

It may thus be seen that the present invention can eliminate direct heat transfer from the refrigerant to the ground to obtain a number of substantial advantages. Rather than dispose the transfer tubing in horizontal orientation in the earth mass, the present invention provides for vertical positioning of refrigeration lines within a volume of water, such that the water circulates by convection to transfer heat to the landmass over a large vertically extending area. Depending upon requirements, several geothermal columns may be provided, each functioning in a similar manner. Land utilization is increased, and installation and servicing is less disruptive.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for installing a geothermal system, comprising the steps of:
boring at least one hole in an earth mass to accept a geothermal column that includes at least one spirally wound refrigeration coil configured to communicate with a heat pump compressor, a hollow tube having an outer wall of diameter substantially greater than that of said at least one spirally wound refrigeration coil and positioned so as to surround said at least one spirally wound refrigeration coil, said outer wall having a substantially rigid configuration such that said hollow tube maintains its shape, and a support member configured to retain a shape of said at least one spirally wound refrigeration coil and maintain a centrally located position of said at least one spirally wound refrigeration coil within said hollow tube;
inserting a geothermal column into each of said at least one hole;
excavating trench lines to accommodate connections between said geothermal column in each of said at least one hole and a Heating/Ventilation/Air Conditioning (HVAC) system;
filling said hollow tube with a non-antifreeze fluid;
connecting said geothermal column to said HVAC system; and
backfilling said at least one hole and said trench lines.

2. The method of claim 1 wherein the bore holes are at least about 23 feet deep.

3. The method of claim 1 wherein the step of boring at least one hole comprises boring a plurality of holes in a predetermined pattern.

4. The method of claim 3 wherein each geothermal column is connected to a distribution section via respective insulated lines.

5. The method of claim 4 wherein each said line ranges in diameter from ¼″ to 1.0″.

6. The method of claim 4 wherein said lines are disposed within flexible piping.

7. The method of claim 1 wherein the trench lines range from about 4″ wide to about 30″ wide.

8. The method of claim 1 wherein the trench lines are at least about 36″ deep.

9. The method of claim 1 wherein the non-antifreeze fluid is water.

10. The method of claim 1 wherein water is applied to the earth mass in the hole during the backfilling operation.

11. A method of heating/cooling a structure using a geothermal column, comprising the steps of:
circulating a refrigerant through at least one geothermal column positioned within an earth mass and including at least one spirally wound refrigeration coil configured to communicate with a heat pump compressor, a hollow tube having an outer wall of diameter substantially greater than that of said at least one spirally wound refrigeration coil and positioned so as to surround said at least one spirally wound refrigeration coil and filled with a non-antifreeze fluid, and a support member configured to retain a shape of said at least one spirally wound refrigeration coil and maintain a centrally located position of said at least one spirally wound refrigeration coil within said hollow tube; and
at least one of:
in a cooling cycle, transferring heat from said refrigerant into said earth mass through said non-antifreeze fluid to cool said refrigerant and cooling said structure using said cooled refrigerant; and
in a heating cycle, transferring heat from said earth mass into said refrigerant through said non-antifreeze fluid to heat said refrigerant and heating said structure using said heated refrigerant.

12. The method of claim 11 comprising the step of monitoring the temperature of the non-antifreeze fluid in the at least one geothermal column with a controller.

13. The method of claim 12 further including determining whether the temperature of the non-antifreeze fluid is less than a first predetermined threshold temperature or greater than a second predetermined threshold temperature.

14. The method of claim 13 wherein, if the temperature of the non-antifreeze fluid is less than the first threshold temperature the controller sets a low temperature indicator to indicate a low temperature condition has occurred and operation of the geothermal column can be shut down or to signal the addition of warmed water to the geothermal column.

15. The method of claim 13 wherein, if the temperature of the non-antifreeze fluid is greater than the second predetermined threshold temperature the controller sets a high temperature indicator to indicate a high temperature condition and operation of the geothermal column can be shut down or to signal the addition of cooled water to the geothermal column.

16. The method of claim 11 comprising the step of monitoring the amount of non-antifreeze fluid in the hollow tube of the at least one geothermal column with a controller.

17. The method of claim 16 wherein further including the step of determining whether the amount of non-antifreeze fluid is less than predetermined level condition.

18. The method of claim 17 wherein if the amount of non-antifreeze fluid is determined to be less than the predetermined level condition or temperature the controller opens a valve to supply additional non-antifreeze fluid to the at least one geothermal column until the amount of non-antifreeze fluid is no longer less than the predetermined level or temperature.

19. The method of claim 11 wherein the non-antifreeze fluid is water.

20. The method of claim 11 wherein the refrigerant includes a fluorocarbon and a lubricant oil.
